(19) United States
(12) Patent Application Publication
(10) Pub. No.: US 2016/0121395 A1
(43) Pub. Date: May 5, 2016

(54) REACTIVE POWDER, BONDING MATERIAL USING REACTIVE POWDER, BONDED BODY BONDED WITH BONDING MATERIAL AND METHOD FOR PRODUCING BONDED BODY

(71) Applicant: HITACHI, LTD., Tokyo (JP)

(72) Inventors: Hirotsugu KAWANAKA, Tokyo (JP); Masami TAGUCHI, Tokyo (JP); Akio HIROSE, Suita-shi (JP); Tomo OGURA, Suita-shi (JP)

(73) Assignee: HITACHI, LTD., Tokyo (JP)

(21) Appl. No.: 14/893,193

(22) PCT Filed: May 23, 2013
(86) PCT No.: PCT/JP2013/064366

§ 371 Date: Nov. 23, 2015

(51) Int. Cl. B22F 1/00; B23K 35/30; B23K 35/32; B23K 35/36; B32B 7/12; B23K 1/00; C22C 19/00; C22C 28/00; C22C 12/00; C22C 32/00; B23K 35/02; B23K 1/005

(52) U.S. Cl. CPC B22F 1/0003; B23K 35/0238; B23K 35/025; B23K 35/3033; B23K 35/325; B23K 35/36; B23K 1/0056; B23K 1/0016; B23K 1/0004; B23K 1/0006; C22C 19/007; C22C 28/00; C22C 12/00; C22C 32/0073; B32B 7/12; B32B 2250/03

(57) ABSTRACT

There is provided a reactive powder enabling a satisfactory and stable self-propagating high temperature synthesis (SHS) reaction. Also, there is provided a bonding material enabling reliable bonding, by using the reactive powder, while inhibiting thermal degradation of a joint member without depending on a surface shape to be bonded of the joint member. The reactive powder is a reactive powder enabling self-propagating high temperature synthesis including a first material and a second material that chemically react with each other, in which each grain constituting the reactive powder is in a state that first sub-grains made of the first material and second sub-grains made of the second material are disorderly mixed within the grain.

### TECHNICAL FIELD OF THE INVENTION

The present invention relates to a bonding technology, and in particular, relates to a reactive powder utilizing Self-propagating High temperature Synthesis (SHS, also referred to as combustion synthesis), a bonding material using the reactive powder, a bonded body being bonded by means of the bonding material, and a method for producing the bonded body.

### DESCRIPTION OF BACKGROUND ART

SHS is known as a method capable of synthesizing a high-melting-point inorganic compound and an intermetallic compound economically in a short time by utilizing a strong heat of an exothermic chemical reaction between elements without using an external heat source. Even when the synthesis itself of a compound is not intended, SHS is also known as a local heating method utilizing a strong exothermic reaction as a heat source.

For example, Patent Literature 1 (JP 2004-501047 A) discloses a composite reactive multilayer foil comprising: a first set of reactive layers; and a second set of reactive layers in thermal contact with the first set, the layers of the first set having compositions which are relatively more reactive than the second set, whereby the layers of the first set, upon ignition, ignite the less reactive layers of the second set. Patent Literature 1 argues that: utilizing one or more embodiments thereof, it is possible to join bulk materials with very different chemical compositions, thermal properties, and other physical properties more effectively and efficiently.

Patent Literature 2 (WO 95/08654 A) discloses a method for producing a refractory/metal composite comprising a first stage and a second stage, in which the first stage includes the steps of: admixing a first metal powder composed of Al (aluminum) and/or Ni (nickel) powder to a mixture powder composed of a second metal powder and a non-metal powder that are capable of synthesizing an alloy or an intermetallic compound and synthesizing a refractory compound by combustion synthesis method; and molding the admixture powder to form a pellet, and the second stage includes the steps of: placing the pellet into a die; filling a gap between the pellet and the die with a heat-resistant pressurizing medium; initiating the combustion synthesis process in the pellet to cause fusing at least partially and softening the first and second metal powders by heat of the synthesis reaction; and forming a skeleton structure made of the refractory compound, while filling internal gaps within the skeleton structure with the molten and softened metal. Patent Literature 2 argues that: it is possible to provide a densified compact of a ceramic, such as titanium carbide, which is difficult to be produced as a dense sintered compact by conventional combustion synthesis method. In particular, there can be provided a structural material having a ceramic skeleton structure densified with a metallic phase that is filled into the internal gaps by infiltration of fused Ti—Al alloy (or Ti—Al intermetallic compound). In addition, it is possible to provide a novel sintered compact containing superabrasives without limitations in a product size and in abrasive adhesiveness deterioration which are inevitable in a conventional technique.

Patent Literature 3 (JP 2011-210758 A) discloses a method for manufacturing a wafer-bonded semiconductor device by bonding a first wafer substrate and a second wafer substrate together, comprising: a first step of forming in advance a bonding member having a bonding function when heated on the wafer-bonded surface sides of the first wafer substrate and the second wafer substrate; a second step of supplying flux paste containing two or more kinds of powdery materials having reactivity to the surface of the bonding member formed in the first step; and a third step of causing excitation for starting a reaction (specifically, a self-propagating synthesis reaction) of the flux paste supplied in the second step. Patent Literature 3 argues that: it is possible to provide a wafer-bonded semiconductor device with less warpage during wafer bonding through an economical and simple process.

### CITATION LIST

### Patent Literatures

Patent Literature 1: Japanese Patent Laid-open No. 2004-501047;

Patent Literature 2: International Laid-open No. 95/08654; and

Patent Literature 3: Japanese Patent Laid-open No. 2011-210758.

### SUMMARY OF THE INVENTION

### Problems to be Solved by the Invention

When electronic components such as semiconductor devices are to be bonded, device characteristics may thermally be degraded if the entire electronic component is exposed to high temperature due to external heating, which is not desirable. Also when members made of easily oxidizing materials are bonded, entire heating in the air atmosphere oxidizes the easily oxidizing materials, which is not desirable (oxidization of easily oxidizing materials can also be considered as a kind of thermal degradation). In contrast, bonding utilizing SHS enables local internal heating and so is expected as a bonding method capable of inhibiting thermal degradation of electronic components and easily oxidizing materials.

The reactive foil described in the aforementioned Patent Literature 1 would be able to implement a good self-propagating synthesis reaction because reactive materials A and B have a laminated structure and there is a large interface between both materials. In addition, the heat of reaction and the reaction propagation rate can advantageously be controlled easily by controlling a lamination thickness of the reactive materials A and B. Therefore, the reactive foil is considered to have a high potential as a bonding material.

However, the reactive foil in Patent Literature 1 is a very brittle material and can be easily arranged on a two-dimensional plane, but it is disadvantageously difficult to arrange the foil on a three-dimensional irregular plane or a surface with a step. Further, the reactive foil has a compound (compound of brittleness) generated by a self-propagating synthesis reaction remaining in a laminar shape, which is a disadvantage in terms of bonding strength. In Patent Literature 1, an attempt is made to improve the bonding strength by opening the reactive foil at a plurality of locations to partition the generated compound layer, but the fact that a brittle compound is formed in a laminar shape remains unchanged and the bonding strength is prone to be insufficient.

As described above, Patent Literature 2 proposes a technology to overcome difficulties of densification frequently posed as a problem when a refractory/metal composite is produced by the combustion synthesis method (SHS). However, Patent Literature 2 is a technology intended to join/integrate refractories (i.e., heat-resistant materials) and there is almost no need to consider thermal degradation of refractories. That is, it is problematic to apply the technology of Patent Literature 2 to bonding of electronic components in terms of thermal degradation.

The technology in Patent Literature 3 is also a bonding method utilizing SHS. In the bonding method, powder of the reactive material A and powder of the reactive material B are used and flux paste is mixed to prevent oxidation of a bonding portion while holding a mixed state of the reactive material powders. In order that excellent and stable SHS are to be carried out, the respective reactive material powders are desirably in contact with each other. However, according to the technology in Patent Literature 3, the flux paste is present between powder grains of the reactive materials and then contact points of powder grains are reduced, which could make SHS unstable.

In view of the foregoing, it is an objective of the present invention to overcome the above disadvantages and provide a reactive powder that enables a satisfactory and stable self-propagating high temperature synthesis (SHS) reaction. Another objective of the invention is to provide a bonding material enabling reliable bonding while inhibiting thermal degradation of a bonded member without depending on a bonding surface shape of a member to be bonded by using such a reactive powder. Still another objective of the invention is to provide a bonded body being bonded by means of the bonding material, and a method for producing the bonded body.

Incidentally, if the providing costs of the reactive powder, bonding material and bonded body rise, such products become inapplicable as industrial ones. Thus, it is one of essential issues that such products are provided at low cost.

### Solution to Problems

(I) According to one aspect of the present invention, there is provided a reactive powder enabling self-propagating high temperature synthesis, including: a first material and a second material that chemically react with each other, in which each grain constituting the reactive powder is in a state that first sub-grains made of the first material and second sub-grains made of the second material are disorderly mixed (jumbled up) within the grain.

In the above aspect (I) of the invention, the following modifications and changes can be made.

(i) The first sub-grain and the second sub-grain each has a scaly shape and an average thickness of the scaly shape of is 10 nm or more and 1 μm or less.

(ii) The reactive powder has an average grain size of 3 μm or more and 40 μm or less.

(iii) The reactive powder is obtained by intermixing and grinding powder of the first material and powder of the second material.

(II) According to another aspect of the invention, there is provided a bonding material to bond two or more members to be bonded, including: the reactive powder of the invention above and an easy-flowing material fluidized at a temperature lower than a melting point of the members to be bonded.

In the above aspect (II) of the invention, the following modifications and changes can be made.

(iv) The reactive powder and powder of the easy-flowing material are intermixed within the bonding material.

(v) The easy-flowing material is one of a low-melting metal, a filler metal, and a glass.

(vi) The bonding material further includes a paste agent for pasting.

(III) According to still another aspect of the invention, there is provided a bonded body, including two or more members to be bonded and a bonding layer interposed between the members, in which: the bonding layer is formed by fluidizing/solidifying the bonding material of the invention above and has a structure in that compound grains generated by a chemical reaction of the reactive powder are dispersed in a matrix made of the easy-flowing material.

(IV) According to still another aspect of the invention, there is provided a method of for producing a bonded body in which two or more members are bonded, including the steps of: preparing a pre-bonding structure by stacking the members to be bonded via the bonding material of the invention above; applying pressure to the pre-bonding structure; and igniting the reactive powder in the bonding material of the pre-bonding structure to cause a self-propagating high temperature synthesis (SHS) reaction, whereby: the members are bonded by fluidization/solidification of the easy-flowing material, while generating compound grains dispersed in a matrix made of the easy-flowing material resulting of the SHS reaction of the reactive powder.

In the above aspect (IV) of the invention, the following modifications and changes can be made.

(vii) The ignition is caused by one of energization, discharge, laser irradiation, and microwave irradiation.

### Advantages of the Invention

According to the present invention, it is possible to provide a reactive powder that enables a satisfactory and stable self-propagating high temperature synthesis (SHS) reaction. Also, according to the invention, it is possible to provide a bonding material enabling reliable bonding while inhibiting thermal degradation of a bonded member without depending on a bonding surface shape of a member to be bonded by using such a reactive powder. Moreover, it is possible to provide a bonded body being bonded by means of the bonding material and a method for producing the bonded body.

### BRIEF DESCRIPTION OF THE DRAWINGS

FIG. 1A is a schematic drawing showing a cross sectional view of an exemplary grain (spherical grain) constituting a reactive powder according to the present invention;

FIG. 1B is a schematic drawing showing a cross sectional view of another exemplary grain (flat grain) constituting the reactive powder according to the invention;

FIG. 2A is a schematic drawing showing a cross sectional view of an example of a bonded body according to the invention;

FIG. 2B is a schematic drawing showing an enlarged cross sectional view of a bonding layer in FIG. 2A;

FIG. 3 is a schematic drawing showing a cross sectional view of an example of the bonded body being bonded by using a conventional reactive foil;

FIG. 4A is a schematic drawing showing a perspective view of an exemplary arrangement of each member of an assembly when the bonded body of the invention is produced;

FIG. 4B is a schematic drawing showing a plan view of an example of a reactive powder aggregation band in FIG. 4A;

FIG. 5 is a schematic drawing showing a perspective view of an exemplary method for producing the bonded body according to the invention;

FIG. 6 is a schematic drawing showing a perspective view of another exemplary method for producing the bonded body according to the invention;

FIG. 7 is a schematic drawing showing a perspective view of still another exemplary method for producing the bonded body according to the invention;

FIG. 8A is a scanning electron microscopy (SEM) observation image of a reactive powder in Example 1;

FIG. 8B is an SEM observation image of a reactive powder in Example 2;

FIG. 9 is an X-ray diffraction (XRD) chart of the reactive powder (before a compound reaction test) in Example 1; and

FIG. 10 is another XRD chart of the reactive powder (after the compound reaction test) in Example 1.

### DETAILED DESCRIPTION OF THE PREFERRED EMBODIMENTS

Hereinafter, preferred embodiments of the present invention will be described below with reference to the accompanying drawings and the like. The invention is not limited to the specific embodiments described below, but various combinations and modifications can be made without deviating from the spirit and scope of the invention. Also in the drawings, the same reference signs are attached to substantially the same portions to omit a duplicate description.

(Reactive Powder)

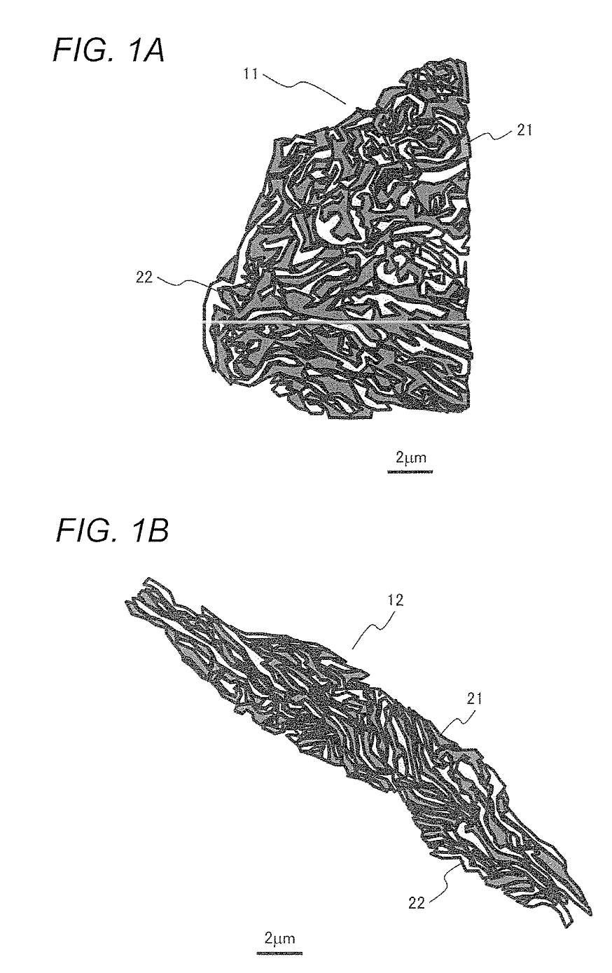

FIG. 1A is a schematic drawing showing a cross sectional view of an exemplary grain (spherical grain) constituting a reactive powder according to the present invention. FIG. 1B is a schematic drawing showing a cross sectional view of an exemplary grain (flat grain) constituting the reactive powder according to the invention. FIGS. 1A and 1B are sketches of photomicrographs and only the range taken as photos (i.e., a portion of the grain) is drawn (the entire grain is not drawn). Meanwhile, in the present invention, the spherical grain does not mean a sphere in a strict sense and means any shape other than a shape considered to be flat, needle-like, or fibrous.

The reactive powder according to the invention is a powder enabling self-propagating high temperature synthesis (SHS) and contains a first material and a second material chemically reacting with each other. Then, in the reactive powder of the invention, as shown in FIGS. 1A and 1B, a spherical grain 11 and a flat grain 12 constituting the powder are each in a disorderly mixed (jumbled) state with first sub-grains 21 made of the first material and second sub-grains 22 made of the second material within one grain. In other words, the grain is considered to be a random system kneaded with the first sub-grains 21 and the second sub-grains 22. The reactive powder of the invention is configured to be able to chemically react with the first material and the second material within one grain. Thus, high efficiency of the chemical reaction can be said to be obtained.

The first sub-grains 21 and the second sub-grains 22 in the spherical grain 11 and the flat grain 12 constituting the reactive powder each has a scaly shape and an average thickness of the scaly shape is preferably 10 nm or more and 1 μm or less, and more preferably 10 nm or more and 100 nm or less. If the average thickness of the sub-grain is larger than 1 μm, the compound reaction becomes unstable and it becomes difficult for a self-propagating high temperature synthesis (SHS) reaction to continue, or the compound reaction itself will not occur. In contrast, if the average thickness of the sub-grain is less than 10 nm, chemical activity of the sub-grain becomes too high and the occurrence possibility of an SHS reaction caused by a physical impact or the like from outside increases even when unnecessary. Incidentally, the average thickness of the sub-grain can be determined from, for example, an image analysis in an electron microscope observation or measurement (Scherrer method) of a crystallite size by powder X-ray diffraction.

The average grain size of the reactive powder (the spherical grain 11 and the flat grain 12) is preferably 3 μm or more and 40 μm or less, and more preferably 3 μm or more and 20 μm or less. If the average grain size of the reactive powder is larger than 40 μm, voids are prone to arise/remain when an SHS reaction is allowed to occur. In contrast, if the average grain size of the reactive powder is less than 3 μm, condensation is prone to occur (that is, both a dense region and a coarse region are prone to arise) and the SHS reaction becomes unstable. Meanwhile, the average grain size of the reactive powder can be determined by using, e.g., a laser diffraction scattering grain size distribution measuring apparatus.

The first material and the second material are not expressly limited if combined as materials used for SHS (combination of materials such that the heat of chemical reaction released from a compound reaction is larger than activation energy to start the compound reaction), and conventional materials can be used. For example, materials between which a silicide reaction occurs (such as a combination of Zr (zirconium) and Si (silicon)), materials between which an intermetallic reaction occurs (such as a combination of Al (aluminum) and Ni (nickel) and another combination of Al and Ti (titanium)), materials between which a boride reaction occurs (such as a combination of Ti and B (boron)), materials between which a carbide reaction occurs (such as a combination of Ti and C (carbon)), and materials between which a termit reaction occurs (such as a combination of Al and Fe₂O₃ (ferric oxide (III)) and another combination of Al and Cu₂O (copper oxide (I))) can be cited.

The aforementioned reactive powder (the spherical grain 11 and the flat grain 12) can be obtained by intermixing and grinding powder of the first material and powder of the second material using, e.g., a ball mill and/or a bead mill. As a concrete condition example, it is preferable to use a planetary ball mill and to intermix and grind materials, e.g., at a rotational rate of 200 rpm for 5 to 7.5 hours. When a bead mill is used, it is preferable to use a bead of, e.g., 0.3 to 2 mm in diameter and to intermix and grind materials at a circumferential rate of 14 m/s for 1 to 2.5 hours. The intermixing and grinding using a ball mill and/or a bead mill may be performed as a dry process or a wet process. The spherical grain 11 as shown in FIG. 1A is more likely to be obtained when the intermixing and grinding is performed as a dry process, and the flat grain 12 as shown in FIG. 1B is more likely to be obtained when the intermixing and grinding is performed as a wet process.

(Bonding Material)

A bonding material according to the invention is used to bond two or more members to be bonded and contains an easy-flowing material that is fluidized at a temperature lower than a melting point of the members to be bonded. In this bonding material, the easy-flowing material is fluidized by the heat of chemical reaction of the reactive powder and solidifies so as to form a bonding layer, which bonds the members to be bonded. The easy-flowing material is not expressly limited and a low-melting metal (e.g., solder), a filler metal (e.g., a brazing filler metal), or a glass (e.g., a low-melting glass) can be suitably used.

As a mixing ratio of the reactive powder and the easy-flowing material in a bonding material of the invention, the reactive powder is preferably 40% by volume or more and 70% by volume or less, in the case that: a low-melting metal or a filler metal is used as an easy-flowing material; an SHS reaction of the reactive powder is caused by one-time ignition to the bonding material; the SHS reaction is continued; and the easy-flowing material is fluidized by the heat of reaction. If the reactive powder is less than 40% by volume, the amount of reactive powder is too small and it is difficult to achieve the continuation of SHS reaction and fluidization of the easy-flowing material at the same time. In contrast, if the reactive powder is more than 70% by volume, the amount of easy-flowing material is insufficient and voids are prone to be generated and to remain in the bonding layer, thus increasing the possibility of poor bonding.

When the bonding material can successively be ignited (for example, when ignited by microwave irradiation or pulse energization), ignition energy can be provided to any reactive powder in the bonding material. In that case, the reactive powder is preferably 30% by volume or more and 70% by volume or less in the bonding material. If the reactive powder is less than 30% by volume, the amount of reactive powder is too small and it is difficult to achieve the fluidization of the easy-flowing material.

When a glass (for example, vanadium containing glass) is used as an easy-flowing material, the reactive powder is preferably 20% by volume or more and 50% by volume or less in the bonding material. The glass contains an oxygen component and frequently promotes the SHS reaction. Thus, the mixing amount of the reactive powder can be reduced when compared with the above case in which a low-melting metal or a filler metal is used. In contrast, if the reactive powder is more than 50% by volume, oxide/carbide is prone to be generated, making the bonding layer brittle.

When the mixing ratio of the reactive powder is rather small, the bonding material is preferably configured such that a layer of the reactive powder is sandwiched between layers of the easy-flowing material (laminated state), in order to keep a stable SHS reaction. In contrast, when the mixing ratio of the reactive powder is rather large or a thick bonding layer is intended to be formed, the bonding material is preferably configured such that the reactive powder and powder of the easy-flowing material are intermixed (mixed state).

In addition, the bonding material of the invention preferably contains a paste agent for pasting. The paste agent is not particularly limited if the configuration state of the reactive powder and the easy-flowing material can be maintained. For example, an organic solvent or flux (fluxing agent) can be used.

The bonding material of the invention includes reactive powder as a material causing the SES reaction, and thus the reactive powder and powder of the easy-flowing material can mixed easily and equally. In addition, by mixing a paste agent for pasting with the bonding material, the bonding material paste can easily be applied and formed on a bonding surface of members without depending on a shape of the surface to be bonded.

(Bonded Body and Producing Method Thereof)

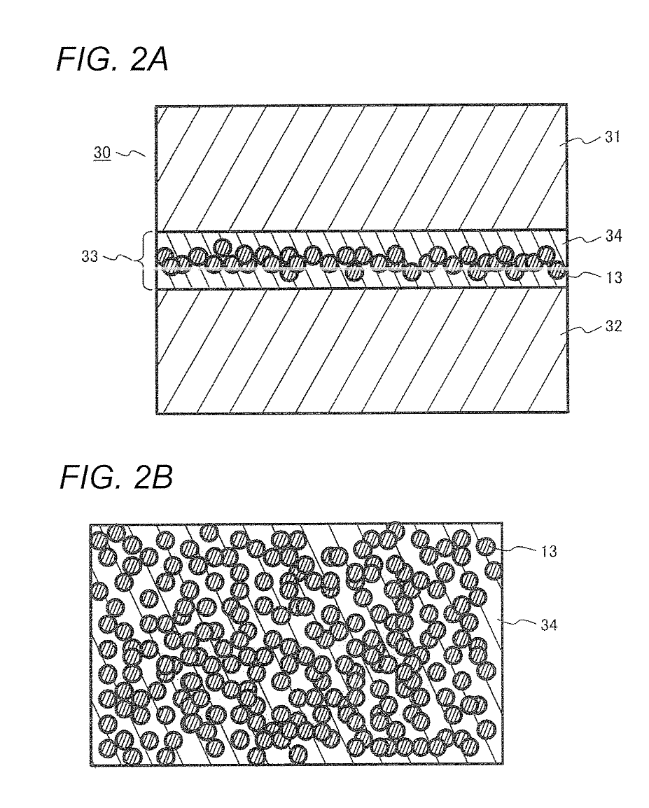

FIG. 2A is a schematic drawing showing a cross sectional view of an example of a bonded body according to the invention, and FIG. 2B is a schematic drawing showing an enlarged cross sectional view of a bonding layer in FIG. 2A. As shown in FIGS. 2A and 2B, a bonded body 30 according to the invention has a structure in which a first joint member 31 and a second joint member 32 are bonded via a bonding layer 33. The bonding layer 33 is formed by fluidizing/solidifying the above bonding material and has a structure so that compound grains 13 generated by a chemical reaction of the reactive powder are dispersed in a matrix made of an easy-flowing material 34.

The first joint member 31 and the second joint member 32 can be materials such as metals, ceramics, glass, and resin, regardless of whether the same material or different materials are used.

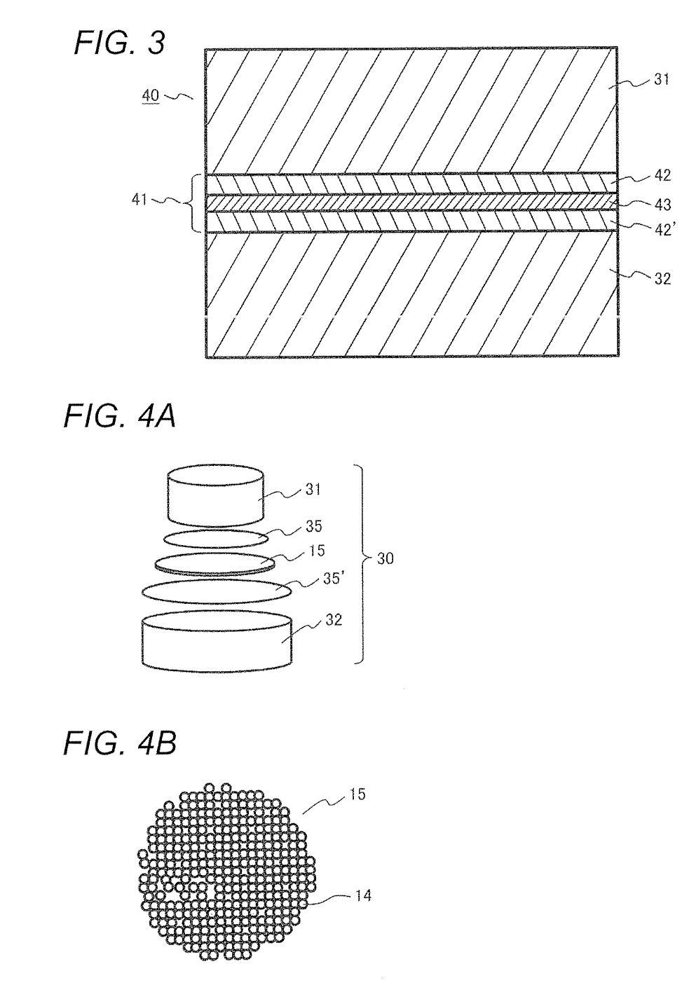

FIG. 3 is a schematic drawing showing a cross sectional view of an example of the bonded body being bonded by using a conventional reactive foil (see Patent Literature 1). As shown in FIG. 3, also a conventional bonded body 40 has a structure in which the first joint member 31 and the second joint member 32 are bonded via a bonding layer 41. However, the bonding layer 41 has a structure so that bonding layers 42, 42′ and a compound layer 43 generated by a chemical reaction of the reactive foil are stacked. The bonding layer 42 is considered to be firmly bonded to the first joint member 31 and the compound layer 43, and the bonding layer 42′ is considered to be firmly bonded to the second joint member 32 and the compound layer 43. However, the compound layer 43 of brittleness is formed in a laminar shape, and thus the bonding strength as a whole is prone to be insufficient disadvantageously.

In the present invention, in contrast, there is provided a structure in which the compound grains 13 are dispersed in the matrix of the easy-flowing material 34, as described above. That is, the easy-flowing material 34 is not partitioned by the compound grains 13 of brittleness, and thus the bonding strength as a whole can be secured. This can be said that because, by using the reactive powder as an SHS reaction source, a three-dimensional network of voids is formed between the generated compound grains 13, and the easy-flowing material 34 that is fluidized can easily penetrate into the network of voids.

Next, a method of for producing a bonded body will be described. FIG. 4A is a schematic drawing showing a perspective view of an exemplary arrangement of each member of an assembly when the bonded body of the invention is produced. FIG. 4B is a schematic drawing showing a plan view of an example of a reactive powder aggregation band in FIG. 4A.

As shown in FIG. 4A, to produce the bonded body 30 of the invention, an easy-flowing material sheet 35, a reactive powder aggregation band 15, and another easy-flowing material sheet 35′ are arranged between the first joint member 31 and the second joint member 32. The reactive powder aggregation band 15 is arranged between the easy-flowing material sheets 35 and 35′. Specifically, as shown in FIG. 4B, the reactive powder aggregation band 15 is an aggregate of reactive powder 14 of the invention. Voids are present between grains of the reactive powder 14 and are connected three-dimensionally.

Meanwhile, in FIG. 4A, the reactive powder aggregation band 15 is depicted as a separate body in order to make the arrangement of each member easier to understand, but in reality, it is a preferable mode that reactive powder paste (a paste obtained after adding and mixing a pasting agent with the reactive powder) is applied to at least one of the easy-flowing material sheets 35 and 35′ and dried.

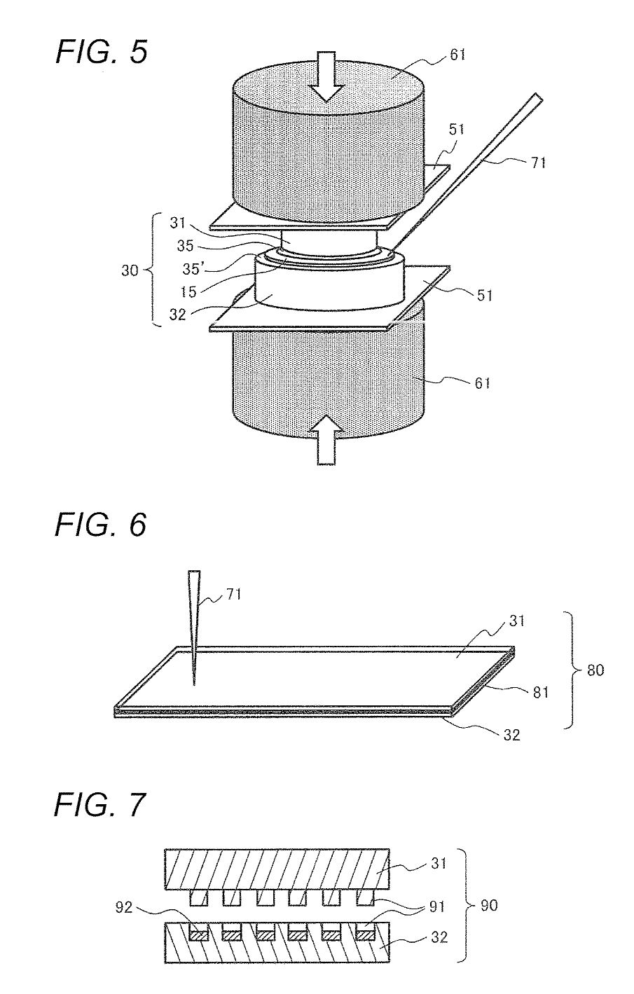

In this embodiment, it is preferable to apply pressure to prevent the contact between the joint members from weakening due to an impact accompanying the SHS reaction of the reactive powder 14. FIG. 5 is a schematic drawing showing a perspective view of an exemplary method for producing the bonded body according to the invention. As shown in FIG. 5, pressure is applied to the bonded body 30 along the directions of arrows in FIG. 5 by means of a pressure device 61. At this time, it is preferable to arrange a cushioning material 51 between the pressure device 61 and the bonded body 30 in order to inhibit the bias of the applied pressure.

When a portion of the reactive powder aggregation band 15 (portion of the reactive powder 14) is ignited by an ignition source 71 while pressure being applied to the bonded body 30 by means of the pressure device 61, the SHS reaction of the reactive powder 14 is caused and the easy-flowing material sheets 35 and 35′ are fluidized/solidified by the heat of reaction so that the first joint member 31 and the second joint member 32 are bonded. The ignition source 71 is not specifically limited as long as energy necessary for starting a synthesis reaction can be provided to the reactive powder 14. For example, energization, discharge, laser irradiation, microwave irradiation or the like can be suitably utilized.

FIG. 6 is a schematic drawing showing a perspective view of another exemplary method for producing the bonded body according to the invention. A bonded body 80 shown in FIG. 6 is an example in which a pair of quartz glass plates is used as the first joint member 31 and the second joint member 32, and a paste obtained by mixing the reactive powder of the invention and a glass powder and by adding a pasting agent thereto is used as a bonding material 81.

The another manufacturing procedure of this embodiment is as follows, for example. First, there is prepared a mixed powder in which the reactive powder of the invention and a powder of low-melting glass containing vanadium are mixed. Next, a pasting agent (organic solvent) is added to the mixed powder and mixed to prepare a bonding material paste. Next, the bonding material 81 (bonding material paste) is applied onto the second joint member 32, and the organic solvent in the bonding material paste is vaporized on a hot plate (e.g., at about 120° C.). After that, the first joint member 31 is put thereon and fastened.

Next, a portion of the bonding material 81 is irradiated with laser (e.g., Yb fiber laser, output: 50 W, 100 ms) as the ignition source 71 from outside the first joint member 31. The quartz glass plate of the joint member allows laser light to pass through, and thus laser irradiation is also possible from the back side of the bonding surface (from outside the joint member). Accordingly, the SHS reaction is caused inside the bonding material 81 and the low-melting glass containing vanadium is fluidized/solidified so that the first joint member 31 and the second joint member 32 are bonded thereto.

FIG. 7 is a schematic drawing showing a perspective view of still another exemplary method for producing the bonded body according to the invention. A bonded body 90 shown in FIG. 7 is an example in which bonding surfaces of the first joint member 31 and the second joint member 32 has a convex-concave structure 91.

The still another manufacturing procedure of this embodiment is as follows, for example. First, a solder paste is added to the reactive powder of the invention and mixed to prepare bonding material paste 92. Next, concave portions of the convex-concave structure 91 are filled with the bonding material paste 92, and then the first joint member 31 and the second joint member 32 are once fitted into each other. After that, the first joint member 31 and the second joint member 32 are detached from each other, thereby the bonding material paste 92 is applied on the bonding surface of each joint member. Next, the solvent component of the bonding material paste 92 is vaporized in an air thermostat chamber (e.g., at about 120° C.), and then these joint members are fitted into each other again and fastened.

Next, pulse energization is performed to the fitted joint members (bonded body 90) while pressure being applied to the fitted joint members. Accordingly, the SHS reaction is caused inside the bonding material paste 92, and the solder is fluidized/solidified so that the first joint member 31 and the second joint member 32 are bonded.

### EXAMPLES

The invention will be described below in more detail by way of specific examples. However, these examples are for illustrative purpose only and are in no way intended to limit the invention.

(Production of Reactive Powder and Bonded Body in Example 1)

Al powder (manufactured by Kojundo Chemical Laboratory Co., Ltd., average grain size of 3 μm) was used as the first material of the reactive powder, and Ni powder (manufactured by Kojundo Chemical Laboratory Co., Ltd., average grain size of 3 μm) was used as the second material. These powders were mixed to prepare a mixed powder. The mixing ratio of the first material and the second material was each 50 atomic %. The mixed powder was input into a ball mill pod (made of SUS304) together with balls (made of SUS304, diameter of ⅜ inches), and dry intermixing and grinding (rotational rate of 200 rpm, for 7.5 hours) of the mixed powder was performed using a planetary ball mill (manufactured by Fritsch Japan Co., Ltd., model: P-5) to obtain a reactive powder in Example 1. The quantity of balls to be input was 15 times the mass of the mixed powder. Also, an organic solvent (α-terpineol) was added and mixed to the obtained reactive powder in order to prepare a bonding material paste in Example 1.

The obtained bonding material paste was used to produce the bonded body 30 in Example 1, based on the manufacturing method of the bonded body shown in FIG. 5. Herein, oxygen free copper (C1020) pellets were used as both the first joint member 31 and the second joint member 32; an indium-tin (52In-48Sn) solder sheet and a bismuth-tin-silver (57Bi-42Sn-1Ag) solder sheet were respectively used as the easy-flowing material sheets 35 and 35′; and an alumina paper sheet was used as cushioning material 51.

After the easy-flowing material sheet 35′ was arranged on the second joint member 32, the bonding material paste was applied onto the easy-flowing material sheet 35′. Next, the organic solvent in the bonding material paste was vaporized on a hot plate (temperature of about 120° C.). After the easy-flowing material sheet 35 and the first bonded member 31 were placed on the dried bonding material, these materials were set to the pressure device 61 via the cushioning materials 51.

Meanwhile, a flux was applied to the bonding surfaces of the first joint member 31 and the second joint member 32 in advance to enhance solder wettability. In addition, holes for allowing laser light to pass through were provided in the cushioning material 51 on the upper side, the first joint member 31, and the easy-flowing material sheet 35.

While pressure being applied for fastening the members by using the pressure device 61, the reactive powder aggregation band 15 was pulse-irradiated with laser light (Yb fiber laser, output of 70 to 140 W, pulse frequency of 500 Hz, 3 to 10 pulses) through the prepared holes. The SHS reaction of the reactive powder in the reactive powder aggregation band 15 was started by pulse irradiation of laser light to generate the compound grains 13, and the easy-flowing material sheets 35 and 35′ (a 52In-48Sn solder sheet and a 57Bi-42Sn-1Ag solder sheet) were melted and solidified to complete the bonding of the first joint member 31 and the second joint member 32.

(Production of Reactive Powder and Bonded Body in Example 2)

The reactive powder, bonding material paste, and bonded body were produced in the same manner as in Example 1, except that, as a method of intermixing and grinding a mixed powder, wet intermixing and grinding by means of a bead mill (manufactured by Ashizawa Finetech Ltd., model: Star mill LMZ2) was adopted instead of the planetary ball mill. The wet intermixing and grinding was performed in a solvent (mineral spirit). Beads (made of zirconia, diameter of 0.8 mm) were input so as to occupy 90% of the volume of a stirring chamber, and intermixing and grinding was performed at the circumferential rate of 14 m/s for 2 hours.

(Production of Reactive Powder in Comparative Example 1)

Al powder (average grain size of 30 μm) was used as the first material of the reactive powder, and Ni powder (average grain size of 150 μm) was used as the second material. These powders were mixed to prepare a mixed powder. The mixing ratio of the first material and the second material was each 50 atomic %. The same planetary ball mill, ball mill pod, and balls as those in Example 1 were used, and dry intermixing and grinding (rotational rate of 150 rpm, for 5 hours) of the mixed powder was performed to obtain a reactive powder in Comparative Example 1. The quantity of balls to be input was like in Example 1. Also, an organic solvent (α-terpineol) was added and mixed to the obtained reactive powder in order to prepare a bonding material paste in Comparative Example 1.

(Production of Reactive Powder in Comparative Example 2)

Al powder (average grain size of 3 μm) was used as the first material of the reactive powder, and Ni powder (average grain size of 3 μm) was used as the second material. These powders were mixed to prepare a mixed powder. The mixing ratio of the first material and the second material was each 50 atomic %. The same planetary ball mill, ball mill pod, and balls as those in Example 1 were used, and dry intermixing and grinding (rotational rate of 200 rpm, for 10 hours) of the mixed powder was performed to obtain a reactive powder in Comparative Example 2. The quantity of balls to be input was like in Example 1. Also, an organic solvent (α-terpineol) was added and mixed to the obtained reactive powder in order to prepare a bonding material paste in Comparative Example 2.

(Production of Reactive Powder in Comparative Example 3)

Al powder (average grain size of 3 μm) was used as the first material of the reactive powder, and dry grinding (rotational rate of 200 rpm, for 7.5 hours) of the Al powder alone was performed under the same conditions as those in Example 1. Next, Ni powder (average grain size of 3 μm) was used as the second material of the reactive powder, and dry grinding (rotational) rate of 200 rpm, for 7.5 hours) of the Ni powder alone was performed under the same conditions as those in Example 1. Then, the ground Al and Ni powders were simply mixed to obtain a reactive powder in Comparative Example 3. The mixing ratio of the first material and the second material was each 50 atomic %. Also, an organic solvent (α-terpineol) was added and mixed to the obtained reactive powder in order to prepare a bonding material paste in Comparative Example 3.

(Measurement/Evaluation)

(1) Grain Size Measurement of Reactive Powder

Grain size measurements of the reactive powders produced as described above (Examples 1 and 2 and Comparative Examples 1 to 3) were carried out using a laser diffraction scattering particle size analyzer (manufactured by Horiba Ltd., model: LA950). Results of the measurements were as follows: The average grain size of the reactive powder in Example 1 was 32 μm; that of the reactive powder in Example 2 was 13 μm; that of the reactive powder in Comparative Example 1 was 80 μm; that of the reactive powder in Comparative Example 2 was 30 μm; and that of the reactive powder in Comparative Example 3 was 150 μm.

(2) Microstructure Observation/Composition Analysis

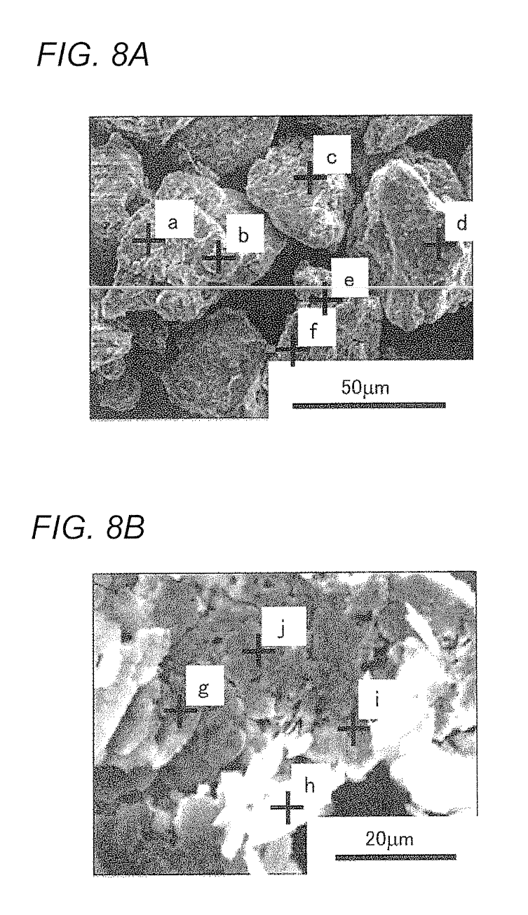

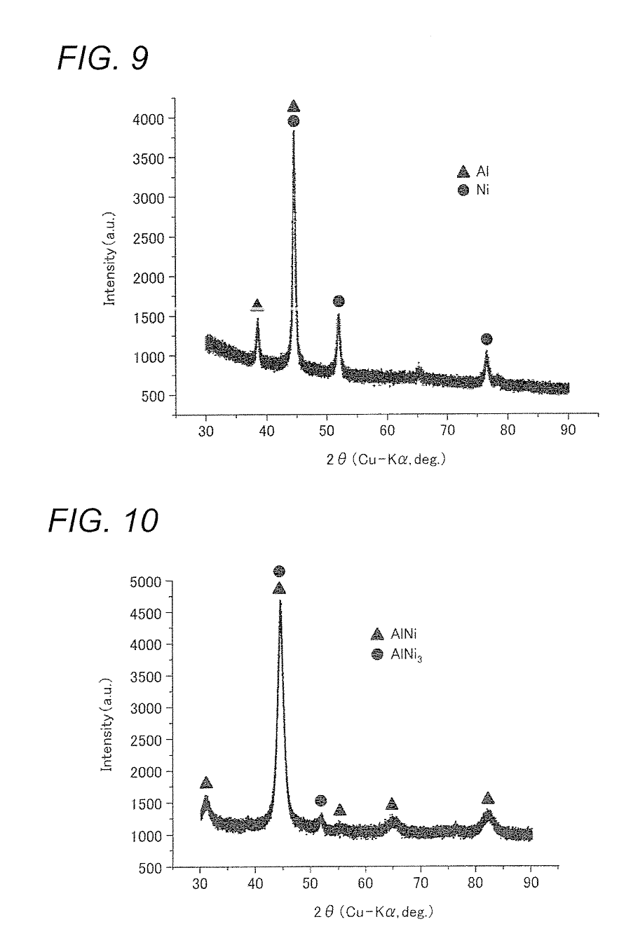

Microstructure observations and composition analyses of the reactive powders produced as described above (Examples 1 and 2 and Comparative Examples 1 to 3) were carried out using a scanning electron microscope-energy dispersive X-ray analyzer (SEM-EDX, manufactured by Hitachi, Ltd., model: S3200N). FIG. 8A is an SEM observation image of the reactive powder in Example 1, and FIG. 8B is an SEM observation image of the reactive powder in Example 2.

As shown in FIG. 8A, it was verified that the reactive powder in Example 1 prepared by the dry intermixing and grinding was mainly made of spherical grains. In contrast, as shown in FIG. 8B, it was verified that the reactive powder in Example 2 prepared by the wet intermixing and grinding was mainly made of flat grains. Also, in the reactive powders in both Example 1 and Example 2, the formation of sub-grains in a scaly shape in each grain was verified. The average thickness of the sub-grain in a scaly shape determined by the Scherrer method was 10 to 20 nm.

Cross marks in FIGS. 8A and 8B indicate EDX analysis points, and symbols a to j are identification symbols of each analysis point. Composition analysis results of the reactive powder in Example 1 are shown in Table 1, and composition analysis results of the reactive powder in Example 2 are shown in Table 2.

TABLE 1
Results of EDX Analysis of Reactive
Powder in Example 1 (atomic %).

| Analysis Point | Al | Ni | O |
|---|---|---|---|
| a | 56.43 | 35.31 | 8.26 |
| b | 53.05 | 39.19 | 7.76 |
| c | 57.87 | 34.6 | 7.53 |
| d | 48.48 | 45.43 | 6.09 |
| e | 46.28 | 47.94 | 5.79 |
| f | 52.66 | 40.57 | 6.77 |

TABLE 2
Results of EDX Analysis of Reactive
Powder in Example 2 (atomic %).

| Analysis Point | Al | Ni | O |
|---|---|---|---|
| g | 55.15 | 33.47 | 11.38 |
| h | 45.97 | 43.18 | 10.85 |
| i | 45.72 | 41.26 | 12.02 |
| j | 44.34 | 45.48 | 10.17 |

As shown in Tables 1 and 2, the reactive powder in Example 1 and the reactive powder in Example 2 respectively had 44 to 58 atomic % of Al and 33 to 48 atomic % of Ni, and there was almost no difference caused by the grain shapes. Incidentally, the detection of oxygen (O) is considered to result from surface oxidation of the reactive powder.

In contrast, the reactive powder in Comparative Example 1 cannot be considered to have a microstructure in which sub-grains in a scaly shape were disorderly mixed within each grain. Instead, it can be said to have a microstructure of a spherical grain in which Ni grains were contained in an Al matrix. In the reactive powder in Comparative Example 2, the sub-grains considered to be a compound of Al and Ni were present within each grain. In the reactive powder in Comparative Example 3, the formation of the sub-grains within each grain was not verified.

(3) Compound Reaction Test/Crystalline Phase Identification

There were carried out compound reaction tests and crystalline phase identifications before and after the compound reaction tests, to each of the reactive powders produced as described above (Examples 1 and 2 and Comparative Examples 1 to 3). First, the bonding material paste was applied onto a quartz glass substrate, and then an organic solvent in the bonding material paste was vaporized on a hot plate (temperature of about 120° C.). An X-ray diffraction (XRD) measurement of the specimen was conducted to make crystalline phase identification before a compound reaction test. For the XRD measurements, an X-ray diffractometer (manufactured by PANalytical, model: PW3040/60 X'Pert Pro, Cu-Kα ray) was used. Next, the dried bonding material was irradiated with pulsed laser (Yb fiber laser, output of 70 W, pulse frequency of 500 Hz, 5 pulses) to carry out a compound reaction test. Then, the XRD measurements were done again to carry out the crystalline phase identification after the compound reaction test.

It was verified that propagation of the compound reaction occurs in the reactive powder in Example 1 due to pulsed laser irradiation. FIG. 9 is an XRD chart of the reactive powder (before a compound reaction test) in Example 1, and FIG. 10 is another XRD chart of the reactive powder (after the compound reaction test) in Example 1 according to the invention. As shown in FIG. 9, Al and Ni components only were detected before the compound reaction test. From the result of FIG. 9, it was verified that no compound reaction occurred during manufacture of the reactive powder in Example 1. Also, as shown in FIG. 10, AlNi and AlNi₃ compounds were detected after the compound reaction test. From the result of FIG. 10, it was verified that an SHS reaction occurred in the reactive powder through the compound reaction test.

Furthermore, it was verified that the propagation of the compound reaction occurred in the reactive powder in Example 2 by the pulsed laser irradiation. Also in the XRD measurement of Example 2, XRD charts similar to those in FIGS. 9 and 10 were obtained.

On the other hand, from the XRD measurement of the reactive powder in Comparative Example 1, it was verified that no compound reaction was caused during manufacture of the reactive powder and that no propagation of the compound reaction was caused by pulsed laser irradiation. This can be considered that the reactive powder in Comparative Example 1 was by no means in a state in which sub-grains in a scaly shape were disorderly mixed within each grain. Therefore, it is considered that, in Comparative Example 1, the compound reaction itself was less likely to occur and thus it was difficult for the propagation to neighboring grains to occur.

In the reactive powder in Comparative Example 2, the formation of sub-grains within each grain of the reactive powder was verified by the microstructure observations, and the XRD measurements revealed that a compound generated during manufacture of the reactive powder. That is, it is considered that the sub-grains themselves were already Al—Ni compounds. As a result, it is considered that no propagation of the compound reaction was caused even by pulsed laser irradiation.

In the reactive powder in Comparative Example 3, the XRD measurements verified that no compound reaction was generated in the reactive powder, and that no propagation of the compound reaction was caused even by pulsed laser irradiation. This can be considered that because the reactive powder in Comparative Example 3 was a powder in which constituent material grains were simply mixed, each grains was too far from each other to chemically react. Therefore, it is considered that the chemical reaction itself was less likely to occur, and that it was difficult for the propagation to neighboring grains to occur.

(4) Evaluation of the Bonded Body

Inspection by visual observation/touch of the bonded body produced above (Examples 1 and 2) verified that no discoloration by oxidation was observed in oxygen free copper of the first joint member 31 and the second joint member 32. It was also verified that the first joint member 31 and the second joint member 32 were firmly bonded. Incidentally, it was separately verified that the surfaces of the first and the second joint members 31 and 32 made of oxygen free copper were discolored by oxidation when the first and the second joint members 31 and 32 were soldered in the atmosphere. That is, it was verified that bonding using a reactive powder according to the invention and a bonded body joined by using the reactive powder could achieve simple and reliable bonding without exposing entire joint members to high temperature.

(Production of Reactive Powder and Bonded Body in Example 3 and Evaluation of the Bonded Body)

Ti powder (manufactured by Kojundo Chemical Laboratory Co., Ltd., average grain size of 38 μm) was used as the first material of the reactive powder, and B powder (manufactured by H. C. Starck GmbH, average grain size of 3 μm) was used as the second material. These powders were mixed to prepare a mixed powder. The mixing ratio of the first material and the second material was set to 33 atomic % and 67 atomic %, respectively. The same planetary ball mill, ball mill pod, and balls as those in Example 1 were used, and dry intermixing and grinding (rotational rate of 200 rpm, for 5 hours) of the mixed powder was performed to obtain a reactive powder in Example 3. The quantity of balls to be input was like in Example 1.

Next, a powder of low-melting glass containing vanadium (softening point of 219° C., average grain size of 3 μm) was mixed with the obtained reactive powder in the ratio of 50% by volume, and further an organic solvent (α-terpineol) was added and mixed in order to prepare a bonding material paste in Example 3.

The obtained bonding material paste was used to produce a bonded body in Example 3, based on the method for producing the bonded body shown in FIG. 6. A pair of quartz glass plates was used for the first joint member 31 and the second joint member 32. Ignition for bonding was performed by irradiation of laser (Yb fiber laser, output of 70 W, for 100 ms) from outside the first joint member 31.

The SHS reaction was caused inside the bonding material by the laser irradiation. And, the bonding was completed through the fluidization/solidification of the low-melting glass containing vanadium, thus obtaining a bonded body in Example 3. Inspection by visual observation/touch of the obtained bonded body revealed that no specific defect, verifying that simple and reliable bonding could be achieved.

(Production of Bonded Body in Example 4 and Evaluation Thereof)

The reactive powder and the bonding material paste were prepared in the same manner as in Example 2. A bonded body in Example 4 was produced in the same manner as in Example 3 except that a sapphire (Al₂O₃) plate was used for the first joint member 31 and that a pure aluminum (A1100) plate was used for the second joint member 32. Laser irradiation for bonding was provided from outside the sapphire plate.

Inspection by visual observation/touch of the obtained bonded body verified that no discoloration by oxidation was observed in the pure aluminum plate of the second joint member 32. It was also verified that the first joint member 31 and the second joint member 32 were stably bonded. Incidentally, it was separately verified that the surface of the second joint member made of pure aluminum was discolored by oxidation when the sapphire plate and the pure aluminum plate were soldered in the atmosphere. That is, it was verified that bonding using a reactive powder according to the invention and a bonded body joined by using the reactive powder could achieve simple and reliable bonding without exposing entire joint members to high temperature.

(Production of Bonding Material and Bonded Body in Example 5 and Evaluation of the Bonded Body)

The reactive powder was prepared in the same manner as in Example 1. Next, a powder of zinc (Zn) (manufactured by Kojundo Chemical Laboratory Co., Ltd., average grain size of 3 μm) was mixed with the obtained reactive powder in the ratio of 30% by volume, and further an organic solvent (α-terpineol) was added and mixed to prepare a bonding material paste in Example 5.

A bonded body in Example 5 was produced in the same manner as in Example 1 except that pure aluminum (A1100) bulks were used for the first joint member 31 and the second joint member 32, that the above bonding material paste was used as the bonding material, and that pulse energization was applied as a means of ignition, instead of laser irradiation. Ignition for bonding was caused by pulse energization in which a current of 700 A or more was instantaneously input.

In the pulse energization bonding, Joule heating increases in the case that a metal powder is arranged between bonding surfaces. This is because the electric conductive area decreases due to the arranged metal powder, and the electric resistance through the bonding surfaces increases. Furthermore, when a material that eutectic-reacts with a joint member is used, the bonding temperature falls to a eutectic temperature, and thus the bonding time can be advantageously reduced.

In this Example, in addition to causing an SHS reaction of the reactive powder by inputting an instantaneous large-current pulse, a low-melting metal (Zn) that undergoes a eutectic reaction with a joint member (Al) was added to the bonding material. As a result, the bonding temperature could fall down to a eutectic reaction temperature, and the time needed for bonding could be reduced.

Inspection by visual observation/touch of the obtained bonded body verified that no discoloration by oxidation was observed in pure aluminum of the first joint member 31 and the second joint member 32 after being bonded. It was also verified that the first joint member 31 and the second joint member 32 were firmly bonded. Incidentally, it was separately verified that the surfaces of the first and the second joint members 31 and 32 made of pure aluminum were discolored by oxidation when the first and the second joint members 31 and 32 were soldered in the atmosphere. That is, it was verified that bonding using a reactive powder according to the invention and a bonded body joined by using the reactive powder could achieve simple and reliable bonding without exposing entire joint members to high temperature.

(Production of Bonding Material and Bonded Body in Example 6 and Evaluation of the Bonded Body)

The reactive powder is prepared in the same manner as in Example 2. Next, a powder of low-melting glass containing vanadium (softening point of 219° C., average grain size of 3 μm) was mixed with the obtained reactive powder in the ratio of 50% by volume, and further an organic solvent (α-terpineol) was added and mixed in order to prepare a bonding material paste in Example 6.

A bonded body in Example 6 was produced in the same manner as in Example 2 except that a pair of sapphire (Al₂O₃) plates was used for the first joint member 31 and the second joint member 32, that the above bonding material paste was used as the bonding material, and that microwave irradiation is used as a means of ignition, instead of laser irradiation.

Inspection by visual observation/touch of the obtained bonded body revealed that no specific problem of appearance was posed, and that the first joint member 31 and the second joint member 32 were firmly bonded. That is, it was verified that a bonding material using a reactive powder according to the invention allowed an SHS reaction also by microwave irradiation, and that simple and reliable bonding could be achieved.

(Production of Bonding Material and Bonded Body in Example 7 and Evaluation of the Bonded Body)

The reactive powder was prepared in the same manner as in Example 1. Next, a lead-free solder paste (manufactured by Senju Metal Industry Co., Ltd.) was mixed with the obtained reactive powder in the ratio of 50% by volume in order to prepare a bonding material paste in Example 7.

A bonded body in Example 7 was produced based on the method for producing the bonded body shown in FIG. 7 except that oxygen free copper (C1020) bulks were used for the first joint member 31 and the second joint member 32, that the above bonding material paste was used as the bonding material, and that pulse energization was applied as a means of ignition, instead of laser irradiation. The first joint member 31 and the second joint member 32 have the convex-concave structure 91 on the respective bonding surface. Ignition for bonding was caused by pulse energization in which a current of 700 A or more was instantaneously input.

Inspection by visual observation/touch of the obtained bonded body verified that no discoloration by oxidation was observed in oxygen free copper of the first joint member 31 and the second joint member 32 after being bonded. It was also verified that the first bonded member 31 and the second bonded member 32 were firmly bonded. Incidentally, it was separately verified that the surfaces of the first and the second joint members 31 and 32 made of oxygen free copper were discolored by oxidation when soldering was performed in an atmospheric furnace.

That is, from the above results, it was verified that bonding using a reactive powder according to the invention and a bonded body joined by using the reactive powder could achieve simple and reliable bonding without exposing entire joint members to high temperature, even if a convex-concave structure was present on the bonding surface of the joint member.

As described above, it has been proved that a reactive powder according to the present invention enables a satisfactory and stable self-propagating high temperature synthesis (SHS) reaction. Also, it has been proved that a bonding material using the reactive powder enables simple and reliable bonding while inhibiting thermal degradation of a joint member without depending on a shape of the surface to be bonded of the joint member. These advantages lead to improved manufacturing yields of bonded bodies of electronic components and bonded bodies of easily oxidizing members, contributing to lower costs.

The above described embodiments and examples are intended to be illustrative only and in no way limiting. The present invention is not intended to include all features and aspects of the embodiments and examples described above. For example, a part of an example (embodiment) may be substituted for a part of another example (embodiment) or added to another example (embodiment) Also, a part of an example (embodiment) may be removed, or replaced by one or more parts of the other examples (embodiments), or added with one or more parts of the other examples (embodiments).

### LEGEND

11 . . . spherical grain;
12 . . . flat grain;
13 . . . compound grain;
14 . . . reactive powder;
15 . . . reactive powder aggregation band;
21 . . . first sub-grain;
22 . . . second sub-grain;
30 . . . bonded body;
31 . . . first joint member;
32 . . . second joint member;
33 . . . bonding layer;
34 . . . easy-flowing material;
35 and 35′ . . . easy-flowing material sheet;
40 . . . conventional bonded body;
41 . . . bonding layer;
42 and 42′ . . . bonding layer;
43 . . . compound layer;
51 . . . cushioning material;
61 . . . pressure device;
71 . . . ignition source;
80 . . . bonded body;
81 . . . bonding material;
90 . . . bonded body;
91 . . . convex-concave structure; and
92 . . . bonding material paste.

1. A reactive powder enabling self-propagating high temperature synthesis, comprising: a first material and a second material that chemically react with each other,
wherein each grain constituting the reactive powder is in a state that first sub-grains made of the first material and second sub-grains made of the second material are disorderly mixed within the grain.

2. The reactive powder according to claim 1, wherein:
the first sub-grain and the second sub-grain each has a scaly shape and an average thickness of the scaly shape is 10 nm or more and 1 μm or less.

3. The reactive powder according to claim 1, wherein:
the reactive powder has an average grain size of 3 μm or more and 40 μm or less.

4. The reactive powder according to claim 1, wherein:
the reactive powder is obtained by intermixing and grinding powder of the first material and powder of the second material.

5. A bonding material to bond two or more members to be bonded, comprising: the reactive powder according to claim 1; and
an easy-flowing material fluidized at a temperature lower than a melting point of the members to be bonded.

6. The bonding material according to claim 5, wherein:
the reactive powder and powder of the easy-flowing material are intermixed within the bonding material.

7. The bonding material according to claim 5, wherein:
the easy-flowing material is one of a low-melting metal, a filler metal, and a glass.

8. The bonding material according to claim 5, further comprising a paste agent for pasting.

9. A bonded body, comprising two or more members to be bonded and a bonding layer interposed between the members, wherein:
the bonding layer is formed by fluidizing/solidifying the bonding material according to claim 5 and has a structure in which compound grains generated by a chemical reaction of the reactive powder are dispersed in a matrix made of the easy-flowing material.

10. A method for producing a bonded body in which two or more members are bonded, comprising the steps of:
preparing a pre-bonding structure by stacking the members to be bonded via the bonding material according to claim 5;
applying pressure to the pre-bonding structure; and
igniting the reactive powder in the bonding material of the pre-bonding structure to cause a self-propagating high temperature synthesis (SHS) reaction, whereby: the members are bonded by fluidization/solidification of the easy-flowing material, while generating compound grains dispersed in a matrix made of the easy-flowing material resulting of the SHS reaction of the reactive powder.

11. The method for a bonded body according to claim 10, wherein:
the ignition is caused by one of energization, discharge, laser irradiation, and microwave irradiation.

12. The reactive powder according to claim 2 wherein:
the reactive powder has an average grain size of 3 μm or more and 40 μm or less.

13. The bonding material according to claim 5, wherein:
each of the first sub-grain and the second sub-grain in the each grain constituting the reactive powder has a scaly shape and an average thickness of the scaly shape is 10 nm or more and 1 μm or less.

14. The bonding material according to claim 5, wherein:
each of the first sub-grain and the second sub-grain in the each grain constituting the reactive powder has a scaly shape and an average thickness of the scaly shape is 10 nm or more and 1 μm or less; and the reactive powder has an average grain size of 3 μm or more and 40 μm or less.
